(19) United States
(12) Patent Application Publication
(10) Pub. No.: US 2018/0357001 A1
(43) Pub. Date: Dec. 13, 2018

(54) ALLOCATE MEMORY BASED ON MEMORY TYPE REQUEST

(71) Applicant: Hewlett Packard Enterprise Development LP, Houston, TX (US)

(72) Inventors: Roque Luis Scheer, Porto Alegre (BR); Guilherme De Campos Magalhaes, Porto Alegre (BR); Ludmila Cherkasova, Sunnyvale, CA (US); Haris Volos, Palo Alto, CA (US)

(21) Appl. No.: 16/061,221

(22) PCT Filed: Dec. 16, 2015
(86) PCT No.: PCT/US2015/066130

§ 371 Date: Jun. 11, 2018

(51) Int. Cl. G06F 3/06

(52) U.S. Cl. CPC G06F 3/0631; G06F 3/0679; G06F 3/0664; G06F 3/0604

(57) ABSTRACT

Techniques for allocating memory based on memory type request are provided. In one aspect, an application thread may be bound to a first processor. The first processor may be associated with a first memory. A portion of memory may be allocated from the first memory in response to the application thread requesting memory of a first type. A portion of memory from a second memory associated with a second processor may be allocated in response to the application thread requesting memory of a second type.

### BACKGROUND

New memory technologies, such as non-volatile memory hold the promise of fundamentally changing the way computing systems operate. Traditionally, memory was transient and when a memory system lost power, the contents of the memory were lost. New forms of nonvolatile memory, including resistive based memory, such as memristor or phase change memory, and other types of nonvolatile, byte addressable memory hold the promise of revolutionizing the operation of computing systems. Byte addressable non-volatile memory may retain the ability to be accessed by a processor via load and store commands, while at the same time taking on characteristics of persistence demonstrated by block devices, such as hard disks and flash drives.

### BRIEF DESCRIPTION OF THE DRAWINGS

FIG. 1 depicts an example system that may utilize the allocate memory based on memory type request techniques described herein.

FIG. 2 depicts another example system that may utilize the allocate memory based on memory type request techniques described herein.

FIG. 3 depicts an example flow diagram for instructions executable by a processor to implement the allocate memory based on memory type request techniques described herein.

FIG. 4 depicts another example flow diagram for instructions executable by a processor to implement the allocate memory based on memory type request techniques described herein.

FIG. 5 depicts an example flow diagram for a method implementing the allocate memory based on memory type request techniques described herein.

FIG. 6 depicts an example flow diagram for a method implementing the allocate memory based on memory type request techniques described herein.

### DETAILED DESCRIPTION

Although the new non-volatile memory technologies have the possibility to significantly alter the future of computing, those technologies are generally not ready for mainstream adoption. For example, some new memory technologies may still be experimental and are not available outside of research laboratory environments. Other technologies may be commercially available, but the current cost is too high to support wide spread adoption. Thus, a paradox arises. It is difficult to develop new software paradigms that make use of the new forms or memory without having those types of memories available for development use. At the same time, the lack of new software paradigms discourages the economic forces that would cause widespread adoption of the new memory types, resulting in greater availability of the new memory types. In other words, it is difficult to write software for new types of memory when that new type of memory is not yet available, while at the same time, there is no driving force to make that new type of memory more widely available, when there is no software capable of using the new type of memory.

Techniques described herein provide the ability to emulate the new types of memory without having to actually have the new types of memory available. A computing system, such as a non-uniform memory access (NUMA) system may include multiple processors. Each of those processors may be associated with a memory. In some cases, the memory may be a readily available memory technology, such as dynamic random access memory (DRAM).

An emulator may be provided. The emulator may cause an application program thread to be bound to one of the processors (e.g. even though the system may include multiple processors, the instructions that make up the application thread will always execute on the processor to which it is bound). When the application thread allocates memory that is to behave as readily available memory (e.g. DRAM), the memory may be allocated from the memory associated with the processor to which the application thread is bound.

When the application thread wishes to allocate the new type of memory (e.g. non-volatile memory (NVM)), the emulator may cause the memory to be allocated from the memory associated with a processor that is different from the one to which the application thread is bound. In other words, the memory associated with the different processor may be used to emulate the new type of memory. When the application thread attempts to access the new type of memory, the emulator is aware because the memory access involves access to a processor other than the one to which the application is bound. For example, the processor to which the application is bound will know, through normal NUMA mechanisms, when a memory access is to memory associated with a different processor.

The emulator may then introduce characteristics of the new type of memory that is being emulated. For example, some types of NVM may have a latency that is greater than DRAM. When emulating NVM, the emulator may introduce a delay whenever memory is accessed that is not associated with the processor to which the application thread is bound. The injected delay may emulate the additional latency of the NVM. As yet another example, some new types of memory may be more prone to errors than DRAM. Similarly, when accessing the emulated memory on the other processor, the emulator may introduce errors to emulate the higher susceptibility to errors of the new type of memory.

What should be understood is that the techniques described herein may cause requests for non-emulated memory to be satisfied from memory directly associated with the processor to which the application thread is bound. Requests for the emulated new types of memory may be satisfied from a processor to which the application thread is not bound. Thus, any access to the new type of memory will need to traverse the processor to which the application is bound and be serviced by the other processor, thus providing the emulator with an indication that emulated memory is being accessed. The emulator may then introduce any characteristic of the emulated memory that is desired (e.g. additional latency, additional errors, etc.). The techniques described herein are not limited to any particular characteristic.

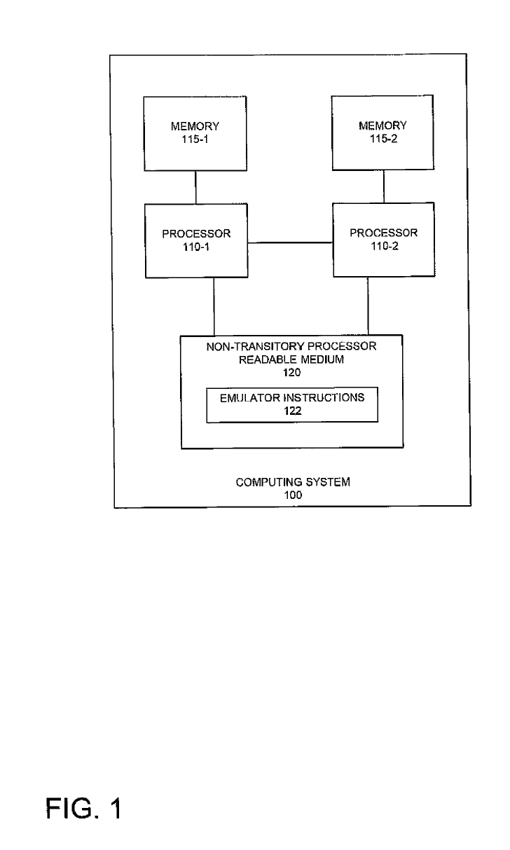

FIG. 1 depicts an example system that may utilize the allocate memory based on memory type request techniques described herein. Computing system 100 may be a NUMA computing system. Although computing system 100 is shown within a single outline box, it should be understood that a NUMA system is not limited to any particular architecture. In general a NUMA system is one in which all memory within the system is accessible by all processors within the system, however the amount of time needed to access the memory may be dependent on the locality of the memory to a given processor. The techniques described herein are applicable to any type of NUMA system, regardless of its architecture.

Computing system 100 may include a first processor 110-1 and a second processor 110-2. Although only two processors are shown, it should be understood that the computing system may also include more than two processors. Each of the processors 110-1,2 may be associated with a memory. As shown, memory 115-1 is associated with processor 110-1, while memory 115-2 is associated with processor 110-2. As previously mentioned, in a NUMA system, each processor is able to access all memory in the system, regardless of which processor the memory is associated with. For example, for processor 110-1, the memory 115-1 may be referred to as the local memory, while the memory 115-2 may be referred to as remote memory. The processor may access the local memory via the memory bus (not shown) associated with processor 110-1. However, if the processor 110-1 wishes to access memory 115-2, the processor 110-1 must send a request to processor 110-2. Processor 110-2 may then access its local memory (in this case memory 115-2). Processor 110-2 may then send the results to processor 110-1. It should be noted that each processor is aware of, and may maintain counts of, when a memory access is to its local memory or to a remote memory. In other words, each processor knows when a memory access request is to its local or a remote memory. The processor may make this information available to the operating system and/or emulator. For example, the processor may make this information available via performance counters.

Computing system 100 may also include a non-transitory processor readable medium 120 containing a set of instructions thereon. The medium may be coupled to the processors 110-1,2. The medium may contain instructions thereon which when executed by the processors, cause the processors to implement the techniques described herein. For example, the medium may include emulator instructions 122. Among other things, the emulator instructions may cause the processor to use the first memory for requests to allocate volatile memory and use the second memory for requests to allocate non-volatile memory. Operation of computing system 100 is described in further detail below.

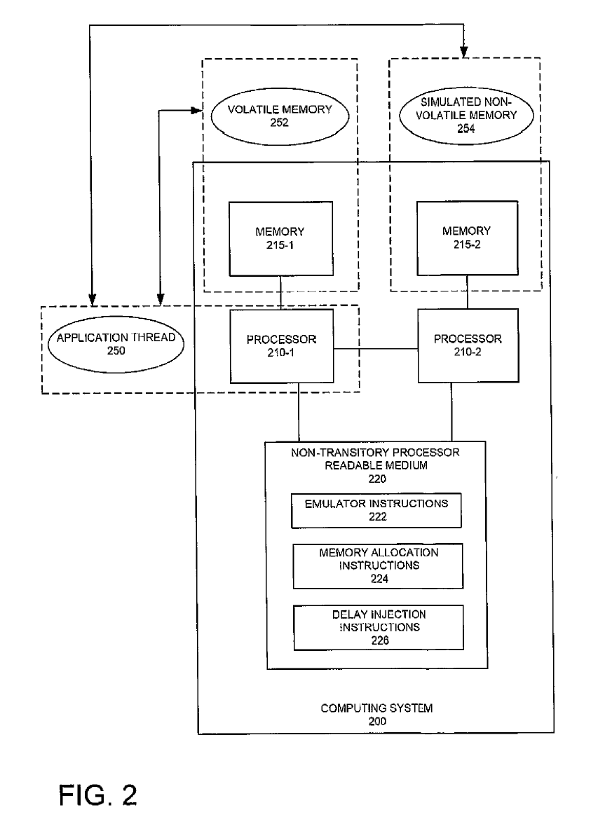

FIG. 2 depicts another example system that may utilize the allocate memory based on memory type request techniques described herein. Many of the components described in FIG. 1 are also included in FIG. 2 and are similarly numbered. For example, computing system 200 is similar to computing system 100, processors 210 are similar to processors 110, memory 215 is similar to memory 115, and medium 220 is similar to medium 120. For ease of understanding, the descriptions of those elements are not repeated here.

Non-transitory medium 220 may also include memory allocation instructions 224. The memory allocation instructions may be executed to allocate the memory 215-1,2 as will be described in further detail below. The medium may also include delay injection instructions 226. The delay injection instructions may be used to inject delays to memory access in order to emulate different types of memory. Operation of computing system 200 is described in further detail below.

In operation, a user may wish to emulate a system that includes both regular memory as well as a new memory technology, when the new memory technology is not yet available for inclusion in an actual system. The user may utilize the emulator and the techniques described herein to emulate such a system. For purposes of this description, regular memory may be referred to as volatile memory, DRAM, or the first memory type. The new memory technology may be referred to as non-volatile memory, NVM, emulated non-volatile memory, or the second memory type. However, it should be understood that this is for ease of description only. The techniques described herein are usable with any type of memory, regardless of the memory being volatile or non-volatile.

For example, the user may wish to emulate the execution of an application thread 250 on a system that includes both DRAM as well as NVM, however the NVM may not yet be available. Using the emulator instructions 222, the user may execute the application thread 250 on computing system 200. The emulator instructions may cause the application thread to be bound to one of the processors in the computing system. As depicted by the dashed line surrounding processor 210-1 and application thread 250, the application thread may be bound to processor 210-1. Binding an application thread to a processor may mean that all instructions that comprise the application thread are executed by the processor to which the application is bound, regardless of if other processors in the system exist. In other words, from the perspective of the application thread, the system consists of only one processor, and that is the processor to which it is bound.

The application thread may desire to allocate memory. In some cases the application thread may desire to allocate volatile memory, while in other cases, the application thread may wish to allocate non-volatile memory. The computing system 200 may provide memory allocation instructions 224 to allow the application thread to request memory allocation. The operation of memory allocation instructions is described in further detail below.

In one implementation, memory allocation instructions 224 may include separate functions for allocating volatile memory and NVM. In other implementations, a single function may be provided, with the function allowing the application thread to specify the type of memory that is being requested. Regardless of implementation, the memory allocation function receives the request for allocation of memory of a certain type. When the memory allocation request is for the first type of memory, the allocation request may be satisfied from the memory associated with the processor to which the application thread is bound. As shown, when a memory allocation request for volatile memory 252 is received, the memory is allocated from the memory 215-1, which is the memory associated with processor 210-1, the processor to which the application thread 250 is bound.

Likewise, when a memory request for allocation of emulated non-volatile memory 254 is received, the memory allocation request is fulfilled by allocating memory that is associated with a process to which the application thread is not bound. As shown, emulated non-volatile memory 254 is allocated from memory 215-2, which is associated with processor 210-2, to which application thread 250 is not bound.

NUMA systems include allocator mechanisms that allow a caller to specify the locality of memory used to fulfill a memory request. For example, the allocation mechanism can specify that local memory is to be use to satisfy a memory request. Likewise, the allocation mechanism may specify that remote memory is to be used to satisfy the memory request. Thus, when application thread 250 requests volatile memory, the allocation instructions can specify that local memory be allocated to satisfy the request. Likewise, when NVM is requested, the allocation instructions may specify that remote memory is allocated.

When the application thread attempts to access either the volatile or emulated non-volatile memory, the processor will know whether that memory is local or remote based on the NUMA allocation mechanisms described above. In the case where the application thread is accessing emulated non-volatile memory, the emulation instructions may inject characteristics that may emulate the characteristics of NVM. For example, in one implementation, the NVM may have greater latency than DRAM. In order to emulate this latency, delay injection instructions 226 may be used to inject a delay for performed non-volatile memory accesses at the boundaries of pre-defined time intervals. In other implementations, the delay may be fixed, or proportional to the ratio of access to the first and second type of memory. In fact, the characteristic to be injected need not be limited to a delay. For example, in some cases, the second type of memory may have an error rate that is higher than the first type of memory. In order to emulate the higher error rate, the emulator may inject errors when accessing the memory of the second type. The rate of injection of errors may be used to emulate the second type of memory and the rate of injection altered to emulate different error rates. What should be understood is that the techniques described herein allow access to the memory of the second type to be detected. Characteristics of the second type of memory, such as latency or error rate, may then be injected in order to emulate the second type of memory, even though the system is not actually equipped with any of the second type of memory. Thus, development of software to utilize the second type or memory may proceed, even though the second type of memory is not available.

The preceding description has generally referred to as an application thread. However, it should be understood that the techniques described herein are not limited to any particular type of application thread. For example, the application thread itself may be some type of virtual system, such as a virtual machine or container that is under the control of a hypervisor. The emulator may be used to cause the hypervisor to allocate memory to the application thread in accordance to the techniques described above.

For example, in a virtual machine implementation, the memory associated with the second processor may be reserved through configuration of the hypervisor, such that the memory associated with the second processor is not available for allocation by the hypervisor. Thus, only the local memory is made available to the hypervisor, and accordingly to the software stack of the virtual machine running under the control of the hypervisor.

The remote memory may then be explicitly mapped by the emulator to a specific part of the address space of the virtual machine that is designated as representing NVM. For example, the memory could be mapped as a character or block device that represents the memory, as a memory based file system, through direct kernel modification of the virtual machine, or any other mechanism. What should be understood is that all memory that is to emulate the second type of memory is allocated from the remote memory. Once this is established, access to the remote memory can be detected, and the desired emulated memory characteristics may be injected.

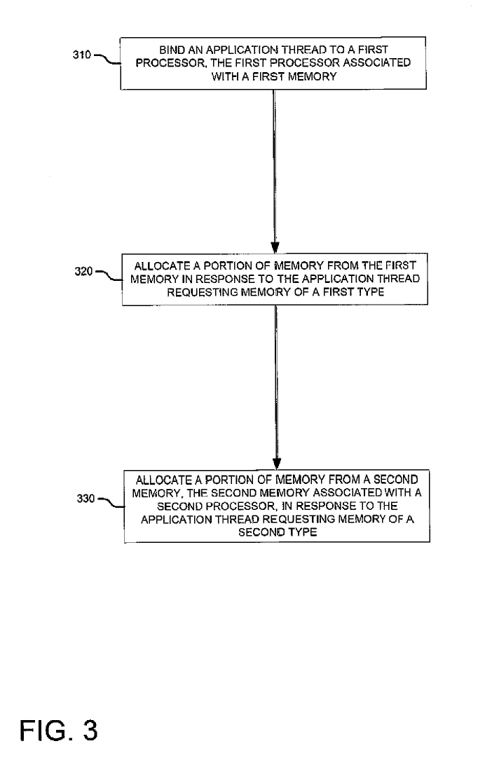

FIG. 3 depicts an example flow diagram for instructions executable by a processor to implement the allocate memory based on memory type request techniques described herein. For example, the instructions may be stored on the non-transitory medium described in FIGS. 1 and 2. In block 310, an application thread may be bound to a first processor, the first processor associated with a first memory. As described above, each processor in a NUMA type system may be associated with its own memory. An application thread may be bound to a processor, meaning that the processor executable instructions that for the application will be executed on the processor to which the application thread is bound, regardless of the total number of processors within the NUMA system.

In block 320, a portion of memory may be allocated from the first memory in response to the application thread requesting memory of a first type. In other words, when the application thread requests memory that is not intended to have additional characteristics imposed on it (e.g. non-emulated memory), the memory will be allocated from the memory that is associated with the processor to which the application is bound. Thus, access to non-emulated memory will not need to involve any other processors within the NUMA system.

In block 330, a portion of memory may be allocated from a second memory, the second memory associated with a second processor. The allocation of the memory associated with the second processor may be in response to the application thread requesting memory of a second type. In other words, when the application thread requests memory that is intended to have additional characteristics imposed on it (e.g. emulated memory), the memory will be allocated from a memory associated with a processor that is different from the one to which the application thread is bound. Thus, access to emulated memory can be detected, because the access will involve communication between the processor to which the application is bound and the processor to which the second memory is associated.

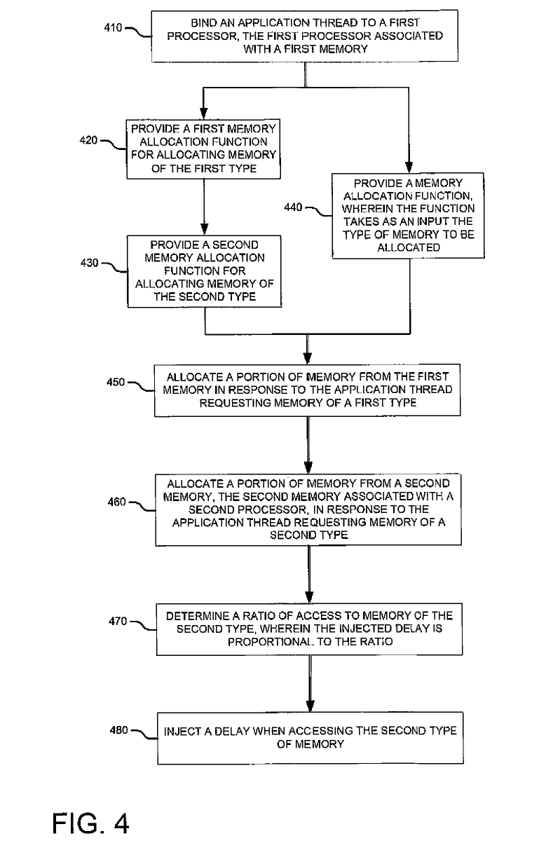

FIG. 4 depicts another example flow diagram for instructions executable by a processor to implement the allocate memory based on memory type request techniques described herein. For example, the instructions may be stored on the non-transitory medium described in FIGS. 1 and 2. In block 410, just as above in block 310, an application thread may be bound to a first processor.

In one example implementation, in block 420, a first memory allocation function may be provided for allocating memory of the first type. For example, many programming languages include a function, such as malloc( ) that may be called when an application thread desires to allocate additional memory. In block 430, a second memory allocation function may be provided to allocating memory of the second type. For example, a function pmalloc( ) (i.e. persistent malloc) may be provided for allocating memory that is to emulate NVM. When an application thread wishes to allocate the first type of memory (e.g. regular memory), the first function is called. When the application thread wishes to allocate the second type of memory (e.g. emulated NVM or other type emulated memory) the second function is called. It should be understood that the function names mentioned above are merely examples, and are not intended to be limiting.

In another example implementation, a memory allocation function may be provided wherein the function takes as an input the type of memory to be allocated. For example, the malloc( ) function described above may be modified to allow the application thread to specify whether the first or second type of memory is being requested. Although two example implementations are described, it should be understood that these are merely examples. The techniques described herein are applicable regardless of the specific mechanism used to allocate memory. Any mechanism that allows an application to specify the type of memory (e.g. regular vs. emulated) requested are suitable for use.

In block 450, just as above in block 320, a portion of memory from the first memory may be allocated in response to the application thread requesting memory of a first type. For example, if the application thread requested memory of the first type using the provided function described in block 420, or specified the type as in block 440, the request is satisfied. Likewise, in block 460, just as in block 330, a portion of memory form the second memory may be allocated in response to the application thread requesting memory of the second type. As above, the request may come from a function provided to request the second type of memory as described in block 430, or from specifying the type of memory requested as described in block 440.

In block 470, a ratio of access to memory of the second type may be determined. An injected delay may be proportional to this ratio. For example, in some implementations, the characteristic to be imposed on the emulated memory may be an additional delay. This delay may be used to emulate the additional latency caused by the emulated NVM. In one implementation, the delay may be determined based on each non-parallel access to the second type of memory. In other implementations, the delay may be based on a ratio of the amount of memory accesses to the second type of memory vs access to all memory, and the introduced delay may be proportional to that ratio. In yet other implementations, the delay may be a fixed value. It should be understood that the techniques described herein are not limited to any particular mechanism for calculating the delay. The first processor may include counters, such as performance counters, that may count the number of CPU stall cycles due to memory accesses to the second type of memory through the second processor. These performance counters may be used when calculating the ratio of memory access types.

In fact, the techniques described herein are not limited to introducing a delay. As mentioned above, another characteristic of the memory to be emulated may be that the emulated memory has a higher error rate. Thus, once it is determined that a memory access is to the second type of memory (e.g. emulated memory), the desired characteristic (e.g. higher error rate) may be injected by the emulator. The techniques described herein may be used to determine when the first or second type of memory is being accessed, and those techniques are applicable regardless of the characteristic that is to be injected.

In block 480, a delay may be injected when access the second type of memory. For example, when emulating NVM with a higher latency than DRAM, access to the second type of memory can cause a delay to be introduced. However, as mentioned above, the techniques described herein are not limited to emulating increased latency. For example, if a higher error rate is being emulated, errors may be injected when accessing the second type of memory. The techniques described herein are not limited to the injection of any particular type of emulated characteristic. In addition, as explained above, the techniques described herein are not limited to any specific type of application thread. In some examples, the application thread itself may be a virtual system, such as a virtual machine, container, or other type of virtual system that is itself emulating another computing system.

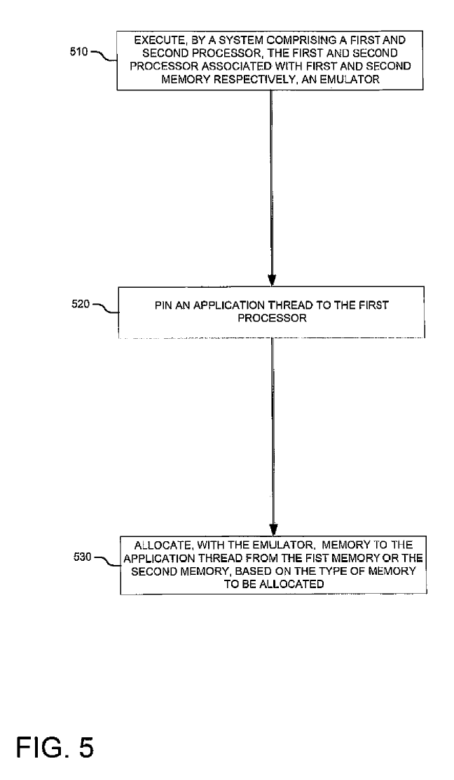

FIG. 5 depicts an example flow diagram far a method implementing the allocate memory based on memory type request techniques described herein. The method described may be implemented by the system described in FIGS. 1 and 2. For example, the method may be implemented as the instructions contained on the non-transitory processor readable medium described above. In block 510, a system comprising a first and second processor, the first and second processor associated with a first and second memory respectively, may execute an emulator. For example, the system may be a two processor NUMA system, with each processor associated with its own memory. The system may execute an emulator to emulate characteristics of different types of memory.

In block 520, an application thread may be pinned to the first processor. As explained above, binding an application thread to a processor means that the processor executable instructions that make up the application thread are only executed by the processor to which the application thread is bound, regardless of the number of processors available within the NINA system. Pinning an application thread to a processor may be synonymous with binding the application thread to a processor.

In block 530, the emulator may allocate memory to the application thread from the first memory or the second memory, based on the type of memory requested. As explained above, the application thread may request non-emulated memory, which is then allocated from the memory associated with the processor to which the application thread is pinned. The application thread may also request emulated memory, which is then allocated from the memory associated with a processor to which the application thread is not pinned.

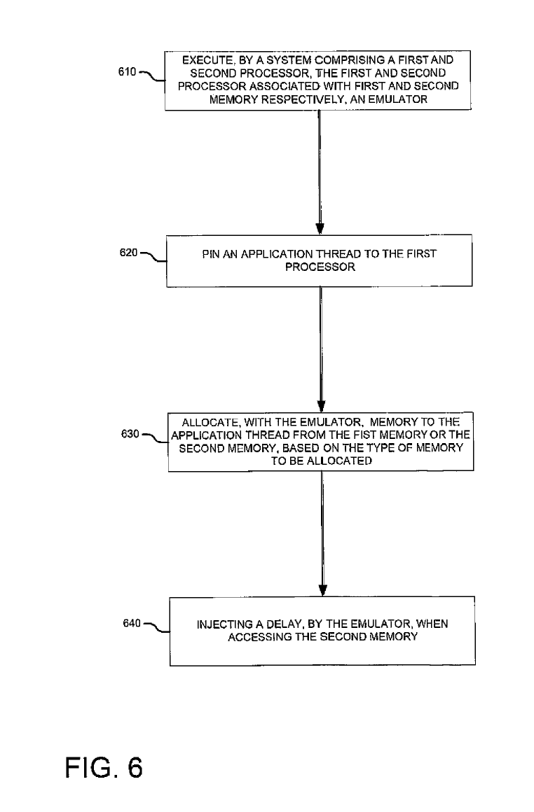

FIG. 6 depicts an example flow diagram for a method implementing the allocate memory based on memory type request techniques described herein. The method described may be implemented by the system described in FIGS. 1 and 2. For example, the method may be implemented as the instructions contained on the non-transitory processor readable medium described above. The flow diagram of FIG. 6 is similar to the one described in FIG. 5. For example, Block 610 is similar to block 510, in which an emulator is executed on a multiprocessor system. Likewise, block 620 is similar to block 520, in which an application thread is pinned to a first processor. Finally, block 630, is similar to block 530, in which the emulator allocates memory to the application based on the type of memory requested by the application.

In block 640, a delay may be injected by the emulator when accessing the second memory. As mentioned above, in one example implementation, the second memory may be used to emulate a memory with higher latency than the first memory. An injected delay may be used to emulate that higher latency. However, it should be understood that the techniques described herein are not limited to injecting a delay. For example, in some example implementations, error may be introduced to emulate a higher error rate of the second type of memory. The techniques described herein are not limited to the injection of any particular type of characteristic on the second type of memory.

We claim:

1. A non-transitory processor readable medium containing instructions thereon which when executed by a processor cause the processor to:
bind an application thread to a first processor, the first processor associated with a first memory;
allocate a portion of memory from the first memory in response to the application thread requesting memory of a first type; and
allocate a portion of memory from a second memory, the second memory associated with a second processor, in response to the application thread requesting memory of a second type.

2. The medium of claim 1 further comprising instructions to:
inject a delay when accessing the second type of memory.

3. The medium of claim 2 wherein the second type of memory emulates non-volatile memory and the delay emulates latency characteristics of the emulated non-volatile memory.

4. The medium of claim 2 further comprising:
determine a ratio of access to memory of the second type, wherein the injected delay is proportional to the ratio.

5. The medium of claim 2 wherein the ratio is determined based on processor performance counters.

6. The medium of claim 1 further comprising:
provide a first memory allocation function for allocating memory of the first type; and
provide a second memory allocation function for allocating memory of the second type.

7. The medium of claim 1 further comprising:
provide a memory allocation function, wherein the function takes as an input the type of memory to be allocated.

8. The medium of claim 1 wherein the application thread is a virtual machine.

9. A system comprising:
a first processor coupled to a first memory;
a second processor coupled to a second memory; and
emulator instructions executable by the first and second processors, the emulator instructions causing requests for allocation of volatile memory to use the first memory and requests for non-volatile memory to use the second memory.

10. The system of claim 9 further comprising:
injecting a delay when accessing the second memory.

11. The system of claim 9 wherein the first and second processors form a non-uniform memory access system.

12. A method comprising:
executing, by a system comprising a first and second processor, the first and second processor associated with first and second memory respectively, an emulator;
pinning an application thread to the first processor; and
allocating, with the emulator, memory to the application thread from the first memory or the second memory, based on the type of memory requested.

13. The method of claim 12 wherein the second memory emulates non-volatile memory.

14. The method of claim 13 further comprising:
injecting a delay, by the emulator, when accessing the second memory.

15. The method of claim 12 wherein the application thread is a virtual machine.
